(19) United States
(12) Patent Application Publication
(10) Pub. No.: US 2026/0297993 A1
(43) Pub. Date: Oct. 1, 2026

(54) Hasp Device Having a Crash Shackle

(71) Applicant: Bayerische Motoren Werke Aktiengesellschaft, Muenchen (DE)

(72) Inventor: Nicholas ALDERSLEY, Hebertshausen (DE)

(21) Appl. No.: 19/629,279

(22) Filed: Mar. 26, 2026

(30) Foreign Application Priority Data
Mar. 27, 2025 (DE) 10 2025 111 924.4

(51) Int. Cl. E05B 85/04; E05B 77/02; E05B 83/18

(52) U.S. Cl. CPC E05B 85/045; E05B 77/02; E05B 83/18

(57) ABSTRACT

A hasp device of a motor vehicle body lock has a base support, which has a plate-like shackle portion and a plate-like fastening portion, wherein the fastening portion is designed to be connected to a body component, and a shackle, which is connected to the shackle portion. The fastening portion and the shackle portion are each connected together at one end such that, in cross section, they form the legs of a U- or V-shape. The shackle portion has an opening, through which a crash shackle extends, which is connected to the fastening portion. In a normal state, the crash shackle engages around the shackle without being in contact therewith.

### CROSS REFERENCE TO RELATED APPLICATION

This application claims priority under 35 U.S.C. §119 from German Patent Application No. 10 2025 111 924.4, filed Mar. 27, 2025, the entire disclosure of which is herein expressly incorporated by reference.

### BACKGROUND AND SUMMARY

The invention relates to a hasp device of a motor vehicle body lock, as is used, for example, for locking a trunk lid or trunk deck. Furthermore, the invention relates to a motor vehicle body lock and to a motor vehicle having such a hasp device.

Hasps of motor vehicle body locks having crash safety mechanisms are known, for example, from DE 10 2019 102 393 A1.

The present invention addresses the problem of providing an alternative crash safety mechanism. This problem is solved by a hasp device, a motor vehicle body lock having such a hasp device, and a motor vehicle having such a lock, in accordance with the independent claims. Advantageous developments of the invention are the subject matter of the dependent claims.

According to one exemplary embodiment of the invention, a hasp device of a motor vehicle body lock is provided, having a base support, which has a plate-like shackle portion and a plate-like fastening portion, wherein the fastening portion is designed to be connected to a body component and its platform is defined substantially in a yz-plane, and a shackle, which is connected to the shackle portion, wherein the fastening portion and the shackle portion are each connected together, in particular in one piece, in particular monolithically, at one end such that, in cross section, in particular an xz cross section, they form the legs of a U- or V-shape, wherein the shackle portion has an opening, through which a crash shackle or accident shackle extends, which is connected to the fastening portion, wherein, in a normal state, the crash shackle engages around the shackle without being in contact therewith. In particular, a distance of at least 1 mm, in particular 3 mm, for example 3.5 mm, is maintained in this case.

The normal state is accordingly a non-crash state, i.e. normal operating and use conditions outside of a crash state in which the motor vehicle is involved in an accident.

In the normal state, the crash shackle never comes into contact with the shackle legs, even when these move elastically (on account of the spring movement between the fastening portion and the shackle portion). It is only in the event of an accident, when a particular load is exceeded, that the crash shackle comes into contact with the shackle legs and prevents the shackle or the shackle portion from being torn away from the fastening portion.

In this way, sufficient flexibility of the movement of the shackle portion and fastening portion toward and away from one another in the normal state and sufficient strength in a crash state are ensured, and so it is possible to prevent the shackle portion and fastening portion from being torn apart.

According to a further exemplary embodiment of the invention, the shackle is made from a continuous metal rod which has two shackle legs, which extend in particular parallel to one another and between which a shackle eye is formed, wherein the two shackle legs are fastened, in particular non-destructively fastened, in particular welded, on opposite sides of the shackle portion.

According to a further exemplary embodiment of the invention, the shackle leg that is fastened on the side of the shackle portion that faces the fastening portion extends rectilinearly as far as the shackle eye, where the metal rod of the shackle continues rectilinearly in the same direction at the shackle eye and subsequently curves in a direction away from the fastening portion. As a result, the shackle eye extends as rectilinearly as possible toward the motor vehicle body lock, thereby in turn increasing the transverse stiffness of the shackle.

According to a further exemplary embodiment of the invention, the shackle extends within a plane. In particular, the shackle extends within the xz-plane.

Furthermore, the present invention provides a motor vehicle body lock having such a hasp device.

Moreover, the present invention provides a motor vehicle having such a hasp device.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 shows a hasp device according to one exemplary embodiment of the present invention.

### DETAILED DESCRIPTION OF THE DRAWING

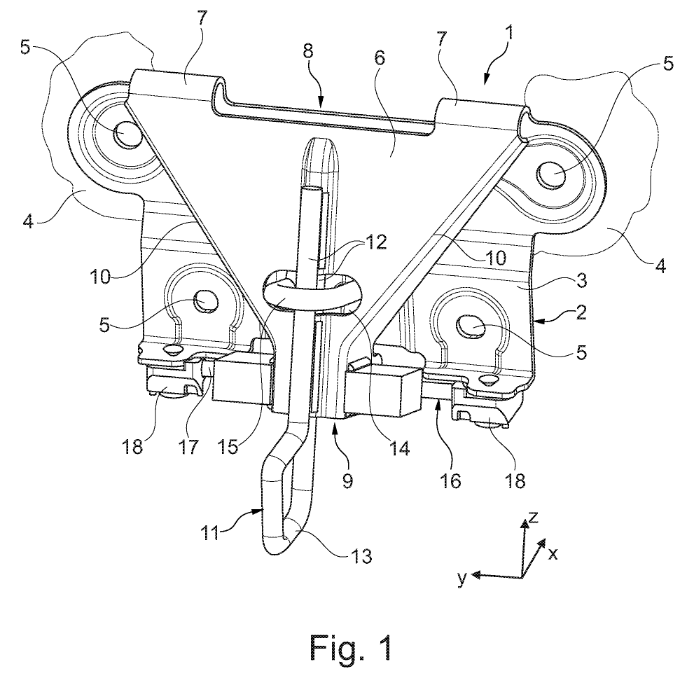

Indicated in FIG. 1 is a coordinate system having an x-axis, a y-axis and a z-axis. These three axes are perpendicular to one another and define a right-angled coordinate system.

The hasp device 1 has a base support 2, which is made of metal, for example steel. The base support 2 has a fastening portion 3, which is plate-like and the plate plane of which is defined substantially in the yz-plane. The fastening portion 3 is designed to be fastened to a body component 4, for example a trunk deck or trunk lid. To this end, the fastening portion 3 is provided with four through-holes 5, through which screws (not illustrated) are able to be fitted, by means of which the fastening portion 3 is screwed to the body component 4. The fastening portion 3 is substantially rectangular (looking along the x-axis).

Furthermore, the base support 2 has a shackle portion 6, which is likewise substantially plate-like. Looking along the x-axis, the shackle portion is substantially triangular. The shackle portion 6 and the fastening portion 3 are connected together via at least one connecting portion 7, wherein two connecting portions 7 are provided in FIG. 1. The fastening portion 3, the shackle portion 6 and the at least one connecting portion 7 are formed in one piece, in particular monolithically. In particular, the shackle portion 6 and the fastening portion 3 are formed by bending a metal sheet.

In cross section through the base support along an xz-plane, the fastening portion 3 and the shackle portion 6 form substantially the legs of a V-shape. This means that, starting from one end 8, at which the connecting portions 7 are arranged, toward the opposite end 9, the distance (along the x-axis) between the fastening portion 3 and the shackle portion 6 increases. A U-shape would also be usable, however.

At the margins 10 of the shackle portion 6, which extend from the connected end 8 to the opposite end 9, the outer edges of the shackle portion 6 are bent, such that they face toward the fastening portion; in particular, they are bent at a right angle.

The shackle portion 6 does not absolutely have to be triangular, however, but could also be rectangular, wherein, rather than the margins 10, diagonal edges in the form of beads or steps are formed, in order in this way to form reinforcements (instead of the margins, but at the position of the margins 10).

A shackle 11, which cooperates with a motor vehicle body lock (not illustrated), is fastened, in particular welded, to the shackle portion 6. The motor vehicle body lock is a body lock as is known from the prior art, in which a hook engages around the shackle 11 for locking purposes and releases it again for unlocking purposes. The motor vehicle body lock is provided, for example, at the periphery of a trunk opening in the body of a motor vehicle.

Between the two connecting portions 7 is a free portion, at which there is no contact or no connection between the fastening portion 3 and the shackle portion 6. In this way, a longitudinal stiffness in the x-direction of the hasp device 1 or of the shackle 11 can be set via the dimension of the connecting portion 7 or of the connecting portions 7 in the y-direction. If, for example, the dimension of the connecting portions 7 in the y-direction is relatively large, a greater force is required in order to change the distance of the shackle 11 or of the shackle portion 6 from the fastening portion 3. With a smaller dimension, the force is correspondingly smaller.

The shackle 11 is made of a continuous or uninterrupted metal rod, in particular made of steel, having two shackle legs 12, between which a shackle eye 13 has been formed by appropriate shaping of the metal rod. The two shackle legs 12 extend rectilinearly and parallel to one another as far as the shackle eye 13. The shackle legs 12 are securely welded on opposite sides of the shackle portion 6 to the respective surfaces of the sides. In particular, the entire shackle 11 extends within an xz-plane. The shackle eye 13 has a position such that the shackle leg 12 arranged closer to the fastening portion 3 extends rectilinearly as far as the shackle eye 13, continues to extend rectilinearly at the shackle eye, and then bends away from the fastening portion 3. In this way, the shackle 11 or the shackle eye 13 extends as rectilinearly as possible and on the shortest path toward the motor vehicle body lock, thereby increasing the transverse stiffness.

Formed in the shackle portion 6 is an opening 14, through which a crash shackle 15 extends. This crash shackle 15 is, in particular, U-shaped and engages around both shackle legs 12 without coming into contact therewith in a normal state, i.e. with a distance between an inner side of the crash shackle 15 and an outer side of the shackle legs 12. The two ends of the U-shaped shackle extend through the fastening portion 3 and are riveted or welded to the rear side thereof (the side facing away from the shackle portion 6). The normal state is a non-crash state, i.e. normal operating and use conditions outside of a crash state, in which crash state the motor vehicle is involved in an accident. Therefore, in the normal state, the crash shackle 15 never comes into contact with the shackle legs 12, even when these move elastically (on account of the spring movement between the fastening portion 3 and the shackle portion 6). It is only in the event of an accident, when a particular load is exceeded, that the crash shackle 15 comes into contact with the shackle legs 12 and prevents the shackle 11 or the shackle portion 6 from being torn away from the fastening portion 3.

Arranged between the fastening portion 3 and the end 9 of the shackle portion 6 that is opposite to the end 8 connected to the fastening portion 3 is a spring element 16. This spring element 16 has primarily a spring rod 17, which is held by two holders 18, which are in turn fastened to the fastening portion 3. This spring element 16 corresponds to the spring element known from the prior art mentioned at the beginning.

While the invention has been illustrated and described in detail in the drawings and the above description, this illustration and description should be understood as being by way of example and not being limiting, and is not intended to restrict the invention to the disclosed exemplary embodiment. The mere fact that particular features are mentioned in different dependent claims is not intended to indicate that a combination of these features could not also be used to advantage.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hasp device of a motor vehicle body lock, comprising:
a base support comprising a plate-shaped shackle portion and a plate-shaped fastening portion, wherein the fastening portion is configured to be connected to a vehicle body component; and
a shackle connected to the shackle portion,
wherein the fastening portion and the shackle portion are each connected together at one end so that, in cross section, they form legs of a U- or V-shape,
wherein the shackle portion has an opening through which a crash shackle extends, which crash shackle is connected to the fastening portion, and
wherein, in a normal state, the crash shackle engages around the shackle without being in contact therewith.

2. The hasp device according to claim 1, wherein
the shackle is made from a continuous metal rod which has two shackle legs, between which a shackle eye is formed, and
the two shackle legs are fastened on opposite sides of the shackle portion.

3. The hasp device according to claim 2, wherein
the shackle leg that is fastened on the side of the shackle portion that faces the fastening portion extends rectilinearly as far as the shackle eye, where the metal rod of the shackle continues rectilinearly in the same direction at the shackle eye and subsequently curves in a direction away from the fastening portion.

4. The hasp device according to claim 1, wherein the shackle extends within a plane.

5. A motor vehicle body lock comprising a hasp device according to claim 1.

6. A motor vehicle comprising a motor vehicle body lock according to claim 5.
